(19) United States
(12) Patent Application Publication
(10) Pub. No.: US 2013/0139283 A1
(43) Pub. Date: May 30, 2013

(54) COMPOSITIONS COMPRISING NATURAL COMPONENTS FOR PROTECTING PLANT PRODUCTS AND CROPS

(71) Applicants: Yuval Katzir, Mobile Post Hefer (IL); Samir Droby, Baga ElGarbia (IL); Eli Budman, Mobile Post Hof Karmel (IL); Radi Aly, Ramat Yishay (IL); Chaim Sharon, M.P. Hefer (IL); Arie Yaari, Nahariyah (IL); Gilad Agmon, Ramat Hasharon (IL)

(72) Inventors: Yuval Katzir, Mobile Post Hefer (IL); Samir Droby, Baga ElGarbia (IL); Eli Budman, Mobile Post Hof Karmel (IL); Radi Aly, Ramat Yishay (IL); Chaim Sharon, M.P. Hefer (IL); Arie Yaari, Nahariyah (IL); Gilad Agmon, Ramat Hasharon (IL)

(73) Assignee: GANIR (1992) LTD., M.P. Sde Gat (IL)

(21) Appl. No.: 13/814,029

(22) PCT Filed: Aug. 14, 2011
(86) PCT No.: PCT/IL11/00662

§ 371 Date: Feb. 4, 2013

Related U.S. Application Data
(60) Provisional application No. 61/373,853, filed on Aug. 15, 2010.

(51) Int. Cl. A01N 65/08

(52) U.S. Cl. CPC A01N 65/08
USPC 800/298; 424/725; 424/777; 424/774; 424/776; 424/778; 435/267; 426/532

(57) ABSTRACT

The invention provides a method for protecting plants and crops products against a variety of pests. The damages are prevented or mitigated, or the pest infestation is controlled, by applying a composition containing a pomegranate extract onto fruits and vegetables, or by employing it in the vicinity of the plant or crops.

### FIELD OF THE INVENTION

The present invention relates to a method for protecting plants and plant products from pests, and from diseases caused by arthropodes and by microbial pathogens, the method employing a composition containing a pomegranate component or an extract from pomegranate. The method may protect fruits or vegetables against pre- and post-harvest diseases.

### BACKGROUND OF THE INVENTION

The broad use of chemical pesticides in agriculture damages the quality of environment, and often poses serious dangers for human health and environment. Pesticides frequently affect not only the targeted organisms, they may contaminate soil and water, and in certain cases they may even indirectly increase the losses of crop. Since pesticides may have unpredictable ecological effects, introducing new materials for such use is usually subjected to complex regulatory and technological restrictions. There has been a lasting need for new pesticides, also in view of the resistance which regularly evolves among pests toward existing means. Some pesticidal materials resist degradation and circulate in the ecological surroundings for years. Pesticide-related disorders are reported both in humans and animals. It is therefore an object of this invention to provide a more natural pesticidal means, which would be free from legal restrictions and safer for use without posing risk to humans and environment.

It is another object of this invention to provide an environmentally-friendly, efficient and economical means for protecting crops and plants from a wide range of pests and diseases.

Other objects and advantages of present invention will appear as description proceeds.

### SUMMARY OF THE INVENTION

This invention provides a method for protecting an item selected from the group consisting of plants, plant products, fruits, vegetables, and crops against pests, comprising i) preparing a composition comprising a pomegranate extract or a pomegranate component; and ii) contacting said item with said composition or applying said composition in the vicinity of to said item; thereby preventing or mitigating damages caused by said pest to said item, and/or controlling infestation by said pest in the vicinity of said item. Applying a composition in the vicinity of an item may comprise placing the composition near to the item without contacting it, or it preferably comprises directly contacting the item with said composition. Said step of preparing the composition preferably comprises extracting pomegranate fruit or a pomegranate component, thereby obtaining a pesticidally active extract. Said step of preparing the composition further preferably comprises lowering the amount of available sugars, possibly by fermenting said extract or by nanofiltration and/or using other membrane technologies, thereby obtaining a pesticidally active extract with lowered amount of sugars. When relating to a lowered amount of sugars, intended is the degradation of monosaccharides, disaccharides, and some oligosaccharides which might otherwise serve as food for organisms potentially damaging for said plant products or crops. Said degradation is achieved, in one embodiment of the invention, by fermenting said pomegranate-based composition by means of microorganisms, such as yeasts. Said step of applying the composition may be performed before or after harvesting said fruits, vegetables, or crops. Said step of applying the composition may comprise spraying, dipping, drenching, coating, and fumigating. Said step of coating may comprise contacting the item with a thin layer of material which contains a pesticidal composition, for example, material comprising a polymer or wax, or packaging film. In a preferred embodiment of the invention, a method is provided for protecting fruits or vegetables, either through controlling the pests in the vicinity of said fruits or vegetables, preferably on the surface of said fruits and vegetables, by means of a pomegranate-derived composition, or through contacting said fruits or vegetables with a pomegranate-derived composition. Said pomegranate component to be employed in the preparation of a pesticidally active composition may comprise peels, husks, membranes, pulp, seeds, flowers, leaves, or mixtures thereof. Said pest to be controlled or suppressed may be selected from the group consisting of viruses, bacteria, fungi, or arthropods like, for example, mites and insects.

The invention relates to a pesticidal composition comprising a pomegranate component or an extract thereof. In a preferred embodiment of the invention, a pesticidal composition comprising a pomegranate component has lowered amount of available sugars, which may be attained, for example, by fermentation of a pomegranate extract. The pesticidal composition according to the invention may comprise a pomegranate extract and an additive selected from the group consisting of diluent, stabilizer, surfactant, organic acid, and at least one additional pesticide selected from bactericide, fungicide, insecticide, and acaricide. Said acid may comprise ascorbic acid, citric acid, or a mixture thereof. Said additional pesticide may comprise, for example, benomyl, o-phenylphenol, diphenyl, thiabendazol, imazalil. In a preferred embodiment, the composition of the invention comprises a pomegranate extract mixed with additives that further increase its pesticidal activity; the additive may act synergistically with the pomegranate component, or it may otherwise enhance the pesticidal activity of the composition. In one aspect of the invention, the composition for protecting plants or crops advantageously contains a pomegranate extract and any pesticide acceptable for use by the regulations. In another aspect of the invention, an environmentally friendly pesticide of natural origin is provided for use in protecting plants or crops from pests selected from the group consisting of microbes and small arthropods.

The invention provides a method of preparing said pesticidal composition, comprising extracting pomegranate fruits or a component thereof, and further optionally lowering the sugar content or increasing active/bioactive components in the extract. The separation or enrichment of a pesticidally active component may employ suitable sorbents and resins, and extractions may be performed by employing water or ethanol, or other organic solvents or solvent mixtures, using sequential extractions when practical, while combining solvents in accordance with hydrophobicity/hydrophilicity of the separated components.

The invention is directed to protecting plants and crops from pests, particularly microbes or small arthropods, by employing compositions comprising pomegranate plant components or extracts thereof. Said microbes may comprise bacteria or fungi or viruses, and said small arthropods may comprise arachnids or insects. In one aspect of the invention, a protecting composition is provided which comprises a pomegranate extract. In another aspect of the invention, a protecting composition is provided which comprises a pomegranate extract and an additive increasing the protecting activity. In an important aspect of the invention, a pomegranate extract and an additive act synergistically. In one embodiment of the invention, the additive comprises organic acids, possibly originating from a natural source like plant or fruit extract. In a preferred embodiment of the invention, a plant or crop protective composition is provided, which comprises a pomegranate extract and an additive comprising ascorbic acid or citric acid or a mixture thereof.

In a preferred embodiment, the invention provides a method for protecting plants, agricultural products, or crops by employing compositions comprising a pomegranate extract and another active component. In the first aspect, said active component is a known synthetic pesticide, and the method of the invention provides a variety of novel and effective pesticidal combinations. In the second aspect, said active component is a natural component of vegetal or mineral origin, and the method of the invention provides environmentally friendly natural pesticides of a broad pest spectrum. Said natural component may be, for example, an extract from plants, fruits or vegetables, or it may be a mineral that lowers the viability of a targeted pest or repels it.

### DETAILED DESCRIPTION OF THE INVENTION

It has now been found that an extract from pomegranates is capable to protect fruits from damages caused by fungal or bacterial pathogens during storage. The extract according to the invention thus efficiently serves as a natural pesticide, and it was found that it may confer the protection to fruits and vegetables before harvest and after harvest. The present invention relates to a pesticide from pomegranate component, preferably derived from pomegranate fruit, and to a method for protecting plants and to a method for postharvest-protecting fruits and vegetables. Moreover, this pesticide can work as a surface and/or air sanitizer for pest control on working surfaces, in refrigerated storage rooms or in rooms with controlled atmosphere, at package lines, etc. The natural pesticidal composition of the invention may be comprised in packaging materials, such as foils, or inside packages containing food products. The environmentally friendly pesticide, in fact of natural origin, can protect plants and trees, in the fields or groves, for example against microorganisms and viruses and against athropodes like acari by way of spray. The natural pesticide of the invention, the extract of a pomegranate fraction as described herein or a composition comprising them, may be used in protecting other food products beside fresh fruits or vegetables as a preservative or as a preservative-supporting agent; the composition according to the invention may assist in protecting processed fruits or vegetables, or any other suitable food product enabling, after taking into consideration the technological and gustatory aspects, the application of said composition.

Generally, materials should meet various criteria in order to be suitable for use as pesticides, comprising toxicity, appearance, odor, etc., and this holds still more for pesticides applied on food products. The composition of the invention meets such criteria, and additionally it is derived from natural sources. Pomegranate extract according to the invention can prevent product spoiling, or it can destroy or control pests. The pests may include vectors of plant disease, or unwanted species causing harm during the production, processing, storage, transport or marketing of plants or agricultural commodities, or said undesired species may otherwise interfere with processing or manufacturing products originating from plants. The extracts may be applied to crops either before or after harvest, for protecting the commodity from being contaminated or from the deterioration of such contamination during storage and transport.

The extracts according to the invention are efficient in protecting various types of fruits against a variety of pests. The following table exemplifies known pests, giving names and some symptoms of the diseases.

| Fruit | Pathogen | Disease |
|---|---|---|
| Avocado | Colletotrichum gloeosportoides | Anthracnose |
| Persea americana | C. acutatum | |
| | Various fungi including: | Stem end rot |
| | Dothiorella spp. | |
| | Lasiodiplodia theobromae | |
| | Stilbella cinnabarina | |
| | Phomopsis perseae | |
| | Ewinia carotovora | Bacterial soft rot |
| Banana | Colletotrichum musae | Anthracnose |
| Musa sapientum | Various fungi including: | Crown rot |
| | Fusarium roseum | |
| | Verticillium spp. | |
| | Acremonium sp. | |
| | Colletotrichum musae | |
| | Thielaviopsis paradoxa | |
| | Deightoniella torulosa | |
| | Various fungi including | Stem end rot |
| | Colletotrichum musae | |
| | Lasiodiplodia theobromae | |
| | Nigrospora sphaerica | Cigar-end rot |
| | Thielaviopsis paradoxa | |
| | Verticillium theobromae and/or | |
| | Trachysphaera fructigena | |
| Cactus (Prickly) Pear | Penicillium sp. | Penecillium rot |
| Opuntia ficus-indica | Alternaria spp. | Alternaria black |
| | | rot |
| | Dothiorella ribis | Dothiorella fruit |
| | | rot |
| Cherimoya | Colletotrichum gloeosporioides | Anthracnose |
| Annona cherimola | Phomopsis anonacearum | Black Canker |
| | Botryodiplodia theobromae | Botryodiplodia rot |
| Citrus | Penicilltum digitatum | Green mold |
| Citrus medica | Penicillium italicum | Blue mould |
| | Alternaria citrti | Black centre rot |
| | Phomopsis citri | Stem end rot |
| | Lasiodeplodia theobromae | |
| | Phytophthora citrophithora | Brown rot |
| | and/or P. parasitica | |
| | Colletotrichum gloeosportoides | Anthracnose |
| Durian | Colletotrichum gloeosporioides | Anthracnose |
| Durio zibethinus | Cylindrocladium scoparium | |
| | Geotrichum citri-aurentii | Sour rot |
| | Lasiodiplodia theobromae | Stem end rot |
| | Phytophthora palmivora | Phytophthora rot |
| | Aspergillus niger | Apergillus black |
| | | rot |
| | Penicillium sp | Penecillium rot |
| Feijoa | Botrytis cinerea | Grey mold |
| Feijoa sellowiana | | |
| Fig | Alternaria alternate | Alternaria rot |
| Ficus carica | Aspergillus niger | Black mold rot |
| | Fusarium moniliforms | Endosepsis |
| | | (pink rot) |
| | Various yeasts and bacteria | Souring |
| | including: | |
| | Saccharomyces sp. and | |
| | Candida sp. | |
| Guava | Colletotrichum gloeosporioides | Anthracnose |
| Psidium guajava | Aspergillus niger | Aspergillus rot |
| | Mucor hiemalis | Mucor rot |
| | Phomopsis destructum | Phomopsis rot |
| | Rhizopus stolonifer | Rhizopus rot |
| Kiwifruit | Botrytis cinerea | Grey mold |
| Actinidia deliciosa | | |
| Litchi | Alternaria sp | Black rot |
| Litchi chinensis | Aspergillus sp | Aspergillus rot |
| | Penicillium sp. | Penicillium rot |
| | Botryodiplodia sp., | Stem end rot |
| | Colletotrichum sp | Anthracnose |
| Loquat | Colletotrichum gloeosporioides, | Anthracnose |
| Eriobotrya japonica | Botrytis cinerea | Grey mold |
| | Pestalotiopsis funereal | Pestalotiopsis rot |
| | Phytopthora cactoarum | Phytophthora rot |
| Mango | Colletotrichum gloeosporioides, | Anthracnose |
| Mangifera indica | C. acutatum | |
| | Dothiarella spp. | Stem end rot |
| | Lasiodiplodia theobromae | |
| | Phomopsus mangiferae | |
| | Pestalotiopsis mangiferae | |
| | Rhizopus stolonifer | Rhizopus rot |
| | Aspergillus niger | Black mould |
| | Alternaria alternata | Alternaria rot |
| | Botrytis cinerea | Grey mould |
| | Penicillium expansum | Blue mould |
| | Mucor circinelloides | Mucor rot |
| Mangosteen | Botryodiplodia theobromae and | Stem et rot |
| Garcinia mangostana | Diplodia sp. and Phomopsis sp. | |
| | Pestalotia flagisettula | Pestalotia rot |
| | Rhizopus sp. | Rhizopus rot |
| Papaya | Colletotrichum spp. | Anthracnose |
| Carica papaya | Phoma caricae-papayae | Black rot |
| | Phomopsis caricae-papayae | Phomopsis rot |
| | Rhizopus stolonifer | Rhizopus rot |
| | Phytophthora palmivora | Phytophthora |
| | | fruit rot |
| Passion Fruit | Alternaria passiflorae | Brown spot |
| Passiflora edulis | Phytophthora nicotianae var. | Phytophthora rot |
| | parasitica | |
| | Septoria passiflorae | Septoria spot |
| Persimmon | Alternaria alternata | Black rot |
| Diospyros kaki | | |
| Pineapple | Thielaviopsis paradoxa | Water blister |
| Ananas comosus | Penicillium funiculosum | Fruit let core rot |
| | Fusarium moniloforme | |
| | var. subglutinans | |
| | Saccharomyces spp. | Yeasty rot |
| | Erwinia ananas | Bacterial brown |
| | | rot |
| Pepino | Alternaria solani | Alternaria Rot |
| Solanum muricatum | | |
| Pomegranate | Aspergillus spp. and | Heart rot |
| | Alternaria sp. | |
| Punica granatum | Botrytis cinerea | Grey mold |
| | Penicillium sp. | Penicillium rot |
| | Aspergillus sp | Aspergillus rot |
| Starfruit | Altenraria alternata | Alternaria rot |
| Averrhoa carambola | Cladosporium cladosporioides | Anthracnose |
| | Botryodiplodia theobromae | Stem end rot |

The pomegranate-based means are used in methods according to the invention for controlling pests infestation in the vicinity of plants, plant products, and crops, or for protecting plant products and crops against pests.

The pests which should be controlled, or whose effects should be mitigated, will often include fungi, some of which are mentioned in the table above. Said pests may include microorganisms like bacteria, and also arthropods such as insects or mites. The insects may include chewing insects, sucking insects, soil insects, possibly comprising flies, mites, hoppers, bugs, aphids, beetles, moths, or larvae, caterpillars, nymphs, and other developmental stages, sometimes called colloquially worms. The pomegranate extracts can protect the plants or plant products particularly from insects belonging to the Hemiptera order, comprising, for example, suborders of Sternorrhyncha and Auchenorrhyncha. The Sternorrhyncha include aphids from the Aphidoidea family, Pseudococcidae, Aleyrodoidea (white flies), Coccoidea (scale insects), Phylloxeroidea and Psylloidea.

This invention provides a method for protecting plants from the pest infestation, and for protecting fruits and plants during postharvest treatment by applying an extract comprising pomegranates. When the term pest is employed here, intended are all kinds of microorganisms and viruses, as well as higher organisms like arthropodes, that cause damages on crops, fruits, or vegetables. The extract of the invention comprises pomegranate fruit or a part of pomegranate tree, such as leaves, peel, flowers, husks, membranes, pulp, seeds or seeds fractions, and mixtures thereof. Liquid extracts, or powders originating from pomegranate fruit are included in the invention. The extract can be applied alone or combined with other natural components that may interact synergistically with the extract, such as essential oils, plant extracts, extracts containing acids, such as ascorbic or citric acid, minerals, and/or beneficial microorganisms like yeasts. The extract can be applied in combination with conventional pesticides as part of a total system approach to the pest management, in order to efficiently reduce the infestation with minimal contamination of the environment. In a preferred aspect of the invention, the pomegranate fruit is extracted, and the extract is employed for protecting the crops or plant products against the pests. The extract can be obtained, in one embodiment, by aqueous extraction, with hot or cold water, or in another embodiment by the extraction with solvents, such as ethanol, methanol, or essential oils. The extraction may be performed under higher than normal pressure. The extraction methods may include decanting, centrifuging, filtering through membranes, adsorbing, absorbing (using, for example, diatomaceous earth or carbon), chromatographing, evaporating, and other separation and purification techniques. The employed physical methods may utilize decanters, finishers, centrifuges, filters, sorption resins, ion exchange resins, evaporators, and other devices. In a preferred embodiment, the process for the preparation of the pomegranate-based pesticidal means includes removing sugars from the pomegranate fractions or extract before the pesticidal use. Said removing sugars may employ physical, chemical or biological methods like nanofiltration and fermentation.

The extract can be modified by techniques used in preparative biochemistry, including enzyme utilization, in order to enrich a specific fraction or to obtain a desired ratio of different fractions. The extract or fractions for the use in a method of the invention can be obtained, for example, by aqueous extraction, by water under pressure, by solvents, ethanol, methanol, essential oils, and/or by physical methods like filtration through membranes, adsorption by resins, or ion exchange resins, or by combinations of them. The extraction process may include removal of sugars by physical, chemical or biological methods like nanofiltration and fermentation.

The method of the invention for protecting plants, plant products, fruits, vegetables, and crops against pests, comprises preparing a composition comprising a pomegranate extract and applying the composition onto the item to be protected or in its vicinity. The composition may be used as prepared or after dilution, wherein the dilution will be easily determined by a skilled person, for example, after simple laboratory tests of the pest sensitivity to several dilutions. For working purposes, the diluted compositions may be characterized by concentrations of some of their components, including sugars, punicalagin, ellagic acid, or total polyphenols (expressed, for example, as gallic acid). A composition according to the invention is usually a pomegranate extract, of which stock before working dilution contains at least 25 gram per liter of total polyphenols, preferably at least 50 gram per liter of total polyphenols, and in many cases 100 gram per liter or more of total polyphenols. If diluting the stock before application of the composition, clean water is used and the dilution is usually between ½ and 1/25. In some applications, a pomegranate extract is applied as prepared. In one embodiment of the invention, the composition before use further contains additives. The additives may aim at adjusting physical properties like viscosity, at simplifying the detection of the composition and its dilution, at increasing the storage stability, or at enhancing the protective effects. A preferred example of an enhancer to be added to the composition of the invention is ascorbic acid, alone or with citric acid, wherein the enhancing effect of the additive is preserved in the composition even after its storage before the use.

Different pomegranate pytochemicals may be concentrated by separation and recomposition, including polyphenols, mainly hydrolysable tannins like ellagitannins and gallotannins, ellagic acid derivates, catechins and procyanidins, anthocyanins and anthocyanidins, flavonols, simple gallyol derivatives, fatty acids and triglycerides (like punicic acid), sterols, terpenoids, alkaloids, and other organic acids. The pesticidally active pomegranate fractions or extracts may be formulated by adding other materials. Mixing with other materials may provide a synergistic effect. A pomegranate-based fraction or extract may be combined with phytochemicals from other sources, including citrus extracts, essential oils, terpenes, antioxidants, phenolic compounds such as phenolic acids, polyphenols, flavonoids, flavonones, carotenoids or other natural colors such as anthocyanins, and others phytoalexins. A preferred composition comprising pomegranates or a fraction thereof, or an extract thereof, further comprises yeasts, for example, Saccharomyces cerevisiae. In a preferred method for controlling pests according to the invention, a pomegranate-based fraction or extract is fermented in order to lower the sugar content available to eventual pests.

The invention provides a composition for employing against diseases in fruits and in vegetables before harvesting, or for protecting fruits and vegetables after harvesting. Said diseases may include green mold of citrus fruit caused by Penicillium digitatum, blue mold of citrus fruit caused by Penicillium italicuin, sour rot of citrus and other fruits (i.e. tomato) caused by Geotrichum (candidum) aurentii, penicillium rot of various fruits and vegetables (apples, pears, plums, apricots) caused by Penicillium expansum, is grey mold of fruits and vegetables as well as plants caused by Botrytis cinerea, black rot/disease caused by Alternaria alternata, fusarium dry rot of fruits and vegetables caused by Fusarium spp., stemphylium rot of anions and plant leaves (tomato) caused by Stemphylium spp., Rhizopus soft rot of fruits and vegetables caused by Rhizopus stolonifer, bacterial soft rot of fruits and vegetables caused by Erwinia carotovora (Pectobacterium carotovora), sour rot of grapes caused by yeast complex, black rot of fruits and vegetables and grains caused by Aspergillus niger.

In a preferred method according to the invention, an extract or fraction comprising pomegranate fruit or a part of the fruit is applied onto plants or fruits or vegetables to be protected from pests and diseases, possibly by means of spraying, dipping, drenching, or inside the wax (for postharvest treatments), or by fumigation. Said spraying or fumigation may comprise creating a fog from a pomegranate-derived liquid or a smoke from a pomegranate-derived powder.

In one embodiment of the invention, an integrated pest management is involved, when the composition according to the invention is combined with other natural pesticidal materials or with known chemical pesticides, or with other known methods used in treating infestation or eliminating pests. A combination with other integrated pest management systems may be employed, comprising biological pest-control means, hot water, controlled atmosphere, and chemical pesticides. Additional active agents may be advantageously added to the compositions of the invention, beside pomegranate-comprising components and extracts, which either act as to complementary agents or synergistic agents; said complementary agents may, for example, broaden the activity of the composition against additional pests; said synergistic agents may, for example, substantially increase the activity of the combined agents against certain pests. The composition of the invention comprises a pomegranate component or extract, together with additives, the additives comprising substances and agents, both active and auxiliary, which do not materially affect the basic and novel characteristic of the present invention.

The method of the invention for protecting plant products and crops against small pests or microbes employs preparing and applying pomegranate-comprising compositions. The compositions according to the invention may comprise extracts of various concentrations, applied alone or with additives further enhancing the efficiency of the treatment. A skilled person will easily adjust the technique of the invention according to the need, in accordance with the type of plant and crop to be protected and in accordance with the pest to be neutralized, while preparing efficient concentrations and employing suitable dilutions, eventually repeating the application of the composition onto or near to the protected item. The method of the invention may provide a wide-spectrum protection against various pests. Moreover, the method of the invention provides a prolonged protection against the pests. In contrast to various publications describing a protection for a few days or sometimes even only for several hours, the composition and the method of the invention provide a prolonged protection against the pests going usually beyond a weeks and often two weeks. In a preferred embodiment of the invention, the composition provides said protection during a period of at least 1 months, and more preferably of at least 2 months. When relating to protection from the pests, what is meant is eliminating the pests, or decreasing their number, in the vicinity of the crops or plants or relevant parts of the plants, and/or lowering fertility of the pests or inhibiting their grows and reproduction, and/or mitigating the effects of the infestation. Of course, in specific cases, when the life cyclus of a pest is known, optimal use of the invention will include repeated applications of the compositions, possibly using known regimens and techniques. According to the requirements of plant growth, harvesting, specific crops treatments and manipulations, various periods of increased protection are needed. The method of the invention provides a prolonged protection, lasting in some embodiments for at least 5 days, in other embodiments for at least 10 days, and in some other embodiments for at least 15 days. In a preferred embodiment of the invention, the method provides a protection lasting for at least 30 days. In another preferred embodiment, the method of the invention provides a protection lasting for at least 60 days. Advantageously, known pesticides, whenever they are acceptable for the required purpose, may be a part of the compositions of the invention and increase their efficiency and universality, including acaricide, biopesticide, bactericide, fungicide, insecticide or insect repellent. The method of the invention may include broader protective means comprising controlling additional types of pests in the vicinity of the protected plants or crops, including applying nematicides, herbicides and the like, or attractant to attract pests away from the plant parts or fruits or crops of interest. The method of the invention provides, according to the needs, both environmentally friendly natural pesticides and highly effective pesticidal combinations. The invention thus provides flexible and broad means for efficient protection of plants or crops.

All the above and other characteristics and advantages of the present invention will be further understood from the following illustrative and non-limitative examples of preferred embodiments.

### EXAMPLES

### Example 1

### Effect of Pomegranate Extracts on Green Mold of Citrus Fruit Caused by Penicillium digitatum

Three different aqueous extracts of pomegranate were checked to protect red grapefruit from infection with Penicillium digitatum:
A. Clear aqueous pomegranate extract 60.7 Brix
B. Cloudy aqueous pomegranate extract 52.3 Brix, and
C. Sugar free clear aqueous pomegranate extract 6 Brix.

Generally, extracts were prepared by chopping the peels, contact them with water and mixing, separating by filtration, and concentrating the soluble solids by evaporation.

The fruits were wounded by puncture and infected with a Penicillium digitatum using 20 μl of spore suspension, 5×10⁴ spores/ml. Three hours later a pomegranate extract or water, 30 μl, was injected to the wounds. The fruits were checked 3 and 6 days after the infection. Totally, 27 fruit pieces were used.

TABLE 1
Effects of pomegranate extracts on the infection of red grapefruit by
Penicillium digitatum; the values are % of fruit wounded sites that
decayed.

| | Decay extent (%) | |
|---|---|---|
| Extract type | After 3 days | After 6 days |
| Control | 96 | 100 |
| A50 | 0 | 0 |
| A30 | 0 | 0 |
| A10 | 0 | 0 |
| B50 | 0 | 0 |
| B30 | 0 | 0 |
| B10 | 0 | 11 |
| C100 | 0 | 0 |
| C50 | 5 | 0 |
| C30 | 6 | 39 |
| C10 | 80 | 93 |

According to the results the extract A was completely efficient up to a 10% dilution with water, the extract B was efficient up to a 30% dilution, and the extract C was efficient at the original concentration.

### Example 2

### Effect of Aqueous Clear Pomegranate Extract on Natural Infection of Citrus Fruit Caused by Penicillium digitatum

Red grapefruits were wounded by puncture and exposed to natural infection during 24 hours, 74 pieces altogether, and then they were dipped in a solution containing 10% of Clear pomegranate extract A or water. The % of decay was checked after 3 and 4 days.

TABLE 2
Effects of a pomegranate extract on the infection of red grapefruit by
Penicillium digitatum; the values are % of fruit wounded sites that
decayed.

| | Decay extent (%) | |
|---|---|---|
| Extract type | After 3 days | After 4 days |
| Control | 73 | 94 |
| A10 | 8 | 29 |

### Example 3

### Effect of Pomegranate Extracts on Infection and Rot Diameter of Penicillium expansum on Pears (cv Spadona)

Freshly harvested pears were wounded and inoculated with a P. expansum spore suspension, 5×10⁵ spores/ml, and treated with various pomegranate extracts:

A. Clear aqueous pomegranate extract, 60.7 Brix

B. Cloudy aqueous pomegranate extract, 52.3 Brix

C. Sugar free clear aqueous pomegranate extract, 6 Brix

D. Sugar free clear alcohol pomegranate extract, 15.1 Brix

E. Pomegranate extract in powder, 10% dilution in water

The concentration level of punicalagins was determined in the samples.

Sugars were removed from the sugar free extracts by fermentation according to one of the following methods:

Method 1:

i) Chopping the peels; ii) contacting the peels with water or diluted ethanol; iii) separating the peels by filtration; iv) fermenting the sugars by inoculating with edible yeasts till almost all the sugars is removed (according to HPLC determination); v) concentrating the soluble solids by evaporation.

Method 2:

i) Chopping the peels; ii) inoculating the peels with edible yeasts so removing sugars by fermentation; iv) adding water or diluted ethanol; v) separating the peels by filtration; vi) concentrating the soluble solids by evaporation.

TABLE 3
Effects of pomegranate extracts on the infection of pears by
Penicillium expansum; the values are fractions of the fruit wounded
sites that decayed within seven days after the infection.

| Extract type | Decay extent (%) |
|---|---|
| Control | 90 |
| A | 100 |
| B | 100 |
| C | 90 |
| D | 0 |
| E | 30 |

TABLE 4
Effects of pomegranate extracts on the infection of pears by
Penicillium expansum; the values are average rot diameters
measured seven days after the infection.

| Extract type | Rot diameter (cm) |
|---|---|
| Control | 1.6 |
| A | 1.3 |
| B | 0.9 |
| C | 0.7 |
| D | 0 |
| E | 0.1 |

Extract D was completely efficient against Penicillium expansum in pears seven days after the treatment. The other extracts were effective in certain extent. Surprisingly the effect on the infection factor was not dependent on the concentration of punicalagin in the extract.

### Example 4

### Effect of Pomegranate Extracts on Fungi Growth In Vitro

The different extracts were checked in vitro on Penicillum digitatum and Penicillium expansum at different concentrations. In Penicillum digitatum there is a good correlation between the results in vivo and in vitro. The extracts were not effective against Penicillium expansum in vitro, although Extract D was very effective against the mold in vivo. This may be an indication of interactions between the extract and the natural defense mechanisms of the fruit for example by stimulating the production of phytoalexins. The difference between said two molds, in vivo and in vitro, suggests different defense mechanisms for different fruits, diseases and products.

### Example 5

### Effect of Pomegranate Extracts with Additives on Green Mold of Citrus Fruit

After harvest, lemons were wounded at one site (half ways between the stem and the calyx end) and incubated at ambient temp for 24 h. Fruit then was dipped for 1 min in water or in 17% extract (A17), allowed to dry and incubated under moist conditions at 20° C. The sugar free clear aqueous pomegranate extract, that was employed for dilution to 17% with water and dipping, had 33.7 Brix and contained 45,000 ppm punicalagin, 1600 ppm ellagic acid, and 122,400 ppm total polyphenols as gallic acid (by Folin Ciocalteu). Each treatment included 50 fruit pieces. After the treatment, fruit was kept under moist conditions to promote infection, kept at 20° C. and observed for development of decay after 6 and 14 days.

Treatments after wounding included:

1. Control, dipping in water

2. Extract, dipping after 3 hours in A17

3. Extract, dipping after 3 hours in A17 with ascorbic and citric acids

4. Extract, dipping after 24 hours in A17

5. Extract, dipping after 24 hours in A17 with ascorbic and citric acids

TABLE 4
Effects of pomegranate extracts on the infection of lemon by green
mold; the values are fractions of the fruit wounded sites that
decayed within seven days after the infection.

| | % decay | % decay |
|---|---|---|
| | in 6 days | in 14 days |
| Control | 74 | 92 |
| C17 after 3 hr | 20 | 52 |
| C17 + citric acid + vitamin C after 3 hr | 6 | 38 |
| C17 after 24 hr | 4 | 30 |
| C17 + citric acid + vitamin C after 24 hr | 0 | 6 |

Regardless the time of the extract application, all treatments resulted in significant control of infection after 6 days of incubation at 20° C. The results show additional positive effects of ascorbic and citric acids.

### Example 6

### Effect of Pomegranate Extracts on Spider Mites Growing on Green Beans Plants

Eight plants of green beans grown to the size of four leaves were sprayed either with a free clear aqueous pomegranate extract, the same as used in Example 5, diluted to 4% (A4) or water (control). After eight days in a controlled room, no toxic effects of the extracts were observed on the sprayed plants, and the plants were infected with spider mites, Tetranychus cinnabarinus, 15 pests per plant. The plants were visually inspected 8 days after the infection, counting the mites and their eggs. The number of adult mites decreased by 30-40% on the extract-treated plant in comparison to the control. Moreover, the number of eggs per adult mite decreased, showing that the diluted extract A4 lowered the fertility of the mites.

### Example 7

### Effect of Pomegranate Extracts on Spider Mites Growing on Green Beans Leaves

200 μl of water or a clear aqueous pomegranate extract, the same as used in Example 5, diluted to 10% (A10) was dripped and spread over the surface of a disc made of a green bean leave. The disc was dried at room temperature for a half hour. Five adult mites were placed on each disc and closed in a glass case, while keeping the air inside humid. Eight treated discs and eight control discs were checked after six days. Of forty adult mites remained 26 in the control group and 27 in the treated group. In the controlled group 408 mite eggs appeared, whereas only 228 in the treated group, clearly demonstrating the protecting potential of the pomegranate extract against the mites. Even the diluted extract A10 lowered the fertility of the spider mites by about 50%.

While the invention has been described using some specific examples, many modifications and variations are possible. It is therefore understood that the invention is not intended to be limited in any way, other than by the scope of the appended claims.

1. A method for protecting an item selected from the group consisting of plants, plant products, fruits, vegetables, and crops against pests, comprising
i) preparing a composition comprising a pomegranate extract; and
ii) contacting said item with said composition or applying said composition in the vicinity of said item;
thereby preventing or mitigating damages caused by said pest to said item, and/or controlling infestation by said pest in the vicinity of said item.

2. The method of claim 1, wherein said step of preparing the composition comprises extracting pomegranate fruit or a pomegranate component, thereby obtaining a pesticidally active extract.

3. The method of claim 2, wherein said step of preparing the composition comprises lowering the amount of sugars in said extract, thereby obtaining a pesticidally active extract with lowered amount of available sugars.

4. The method of claim 1, wherein said step of contacting or applying is performed before harvesting said fruits, vegetables, or crops.

5. The method of claim 1, wherein said step of contacting is performed after harvesting said fruits, vegetables, or crops.

6. The method of claim 1, wherein said step of contacting or applying comprises spraying, dipping, drenching, coating, and fumigating.

7. The method of claim 6, wherein said step of coating comprises contacting the item with a thin layer comprising said composition.

8. The method of claim 7, wherein said thin layer comprises a polymer or wax.

9. The method of claim 1, wherein said item comprises fruits or vegetables.

10. The method of claim 2, wherein said pomegranate component comprises peel, husks, membranes, pulp, seeds, flowers, leaves, and mixtures thereof.

11. The method of claim 1, wherein said pest is selected from the group consisting of viruses, bacteria, fungi, mites, and insects.

12. A pesticidal composition comprising a pomegranate component or an extract thereof.

13. A pesticidal composition according to claim 12, comprising a pomegranate component with a lowered amount of available sugars.

14. A pesticidal composition according to claim 12, comprising a pomegranate extract and an additive selected from the group consisting of diluent, stabilizer, organic acid, and at least one additional pesticidal agent selected from bactericide, fungicide, insecticide, and acaricide.

15. A pesticidal composition according to claim 12, comprising a pomegranate extract and an additive selected from the group consisting of ascorbic acid, citric acid, and a mixture thereof.

16. A composition according to claim 12, being environmentally friendly pesticide of natural origin, for use in protecting plants or crops from pests selected from the group consisting of microbes and small arthropods.

17. A method of preparing the pesticidal composition of claim 12, comprising extracting pomegranate fruits or a component thereof, and fermenting the extract.

18. The method of claim 17, comprising extracting with a solvent selected from the group consisting of water, ethanol, essential oils, and other organic solvents or mixtures thereof.

19. The method of claim 18, further comprising removing said solvent, thereby concentrating the soluble components of said extract, optionally till obtaining a powder.

20. An item selected from the group consisting of plants, plant products, fruits, vegetables, or crops, protected according to the method of claim 5.

21. An item according to claim 20, comprising plants, plant products, fruits, vegetables, or crops, and a composition comprising a pomegranate extract.

22. An item according to claim 20, comprising plants, plant products, fruits, vegetables, or crops sprayed by or dipped in a composition comprising a pomegranate extract.
